(19) United States
(12) Patent Application Publication
(10) Pub. No.: US 2006/0259311 A1
(43) Pub. Date: Nov. 16, 2006

(54) Method and system for targeted marketing through online sporting group registration and maintenance website

(76) Inventors: Erik Stadler, Atlanta, GA (US); Peter E. Santora, Atlanta, GA (US)

Correspondence Address: SUTHERLAND ASBILL & BRENNAN LLP, 999 PEACHTREE STREET, N.E., ATLANTA, GA, 30309, US

(21) Appl. No.: 11/129,780

(22) Filed: May 16, 2005

(51) Int. Cl. G06Q 99/00; G06Q 30/00

(52) U.S. Cl. 705/1; 705/26

(57) ABSTRACT

This invention relates generally to the use of public websites for allowing individuals to register participant for sports leagues, camps, and events and providing targeting advertising for a marketing partner dynamically based on inputted information relevant to the participant. More specifically, this invention relates to a system and method which allows the maintenance of sports leagues, camps and events for an operating group which provides for registration, payment handling, product offers, and other targeted marking.

### FIELD OF THE INVENTION

This invention relates generally to the use of public websites for allowing individuals to register participants for sports leagues, sports camps, and sports events and providing targeting advertising for a marketing partner dynamically based on inputted information relevant to the participant. More specifically, this invention relates to a system and method which allows the maintenance of sports leagues, sports camps and sports events for an operating group which provides for registration, program management, payment handling, product offers, and other targeted marketing.

### DESCRIPTION OF THE RELATED ART

Traditionally, parents are the individuals who register their children as participants in community sports leagues. Most sports leagues require the filling out of paper registration forms, which can either be obtained through printing the forms online or traveling to the operating group's offices to obtain one. The forms are then either mailed, faxed, or hand returned to the operating group for processing. The process can be cumbersome and many opportunities for presenting marketing opportunities are lost.

Furthermore, current registration procedures require the mass printing of various forms designed for each program offered by the operating group. They do not have the capability to effectively present forms directly to an individual based on the previously acquired demographic knowledge of the participants which the individual plans to register for programs.

There currently exist systems meant to solve the above listed problems by allowing individuals to fill out forms by visiting a website associated with or run by the operating group. Many of these systems would allow for example, a parent to register their children for a youth sports league. These systems can also allow for credit card payment for the registration. A major problem with these prior art systems is the lost revenue opportunities made due to the lack of associated marketing through these websites.

These websites which allow for some level of automation in the registration process are generally lacking in program management functionality. The automatic generation of rosters and schedules is a much needed feature in combination with registration capabilities. This greatly increases the incentive for an individual to revisit the website to obtain additional information. Thus, the number of opportunities for targeted marketing could be likewise increased.

Many websites employ marketing techniques through various channels. For example, websites may contain so-called “banner ads”, which typically appear on the header of the page. Such banner ads may contain advertising messages provided by the advertising company who pays revenue to the operator of the site to display the ads. Typically, such advertising is targeted to the type of user that would access the site. For example, gardening tools may be advertised for in a banner ad located on a website that provided gardening tips.

Advertisements on websites can be targeted in other ways. For example, when a user visits a website that provides weather information, that user may enter a location to get more localized temperature information. When the website displays that localized weather information, it may also display an advertisement related to a business located in that same locale. This type of geographical targeted marketing can be more effective for businesses that are not located nationwide.

Targeted product offers are also known in the art. For example, a user purchasing an action movie on a website may be subsequently presented with offers to purchase other movies of the same genre. This type of marketing is effective due to the fact that the user has already exhibited a proclivity for purchasing a particular type of product and thus may be more likely to purchase similar products in the future.

However, a need still exists for operating groups working in combination with marketing partners to provide targeted marketing and targeted offers of sporting equipment to individuals that are participants for sports programs. Furthermore, within sporting leagues and camps different individuals have different roles and responsibilities, and a system and method for target appropriate product offers for them is needed as well.

### SUMMARY OF THE INVENTION

The present invention fulfills these needs through a system and method which allows the maintenance of sports leagues, sports camps and sports events for an operating group which provides for registration, program management, payment handling, product offers, and other targeted marketing. The invention's method of doing this is more focused and specific than the other prior art methods. It is targeted to a specific audience based on entered information and specific relationships between operating groups and marketing partners. Most importantly, it combines the functionality of a program registration and management system with the revenue potential created by targeted marketing.

Websites are well known in the art and used for a myriad of purposes. This invention focuses on a publicly accessible website containing selected content from an operating group. An operating group may be for example, a sports league, a university or other organization that runs sports camps, or any organization coordinating sporting events or programs. In alternative embodiments of this invention, the operating group may be any group that runs or sponsors the above listed programs.

The public website allows for an individual to register with the organization for the purposes of signing up participants for the offered programs. Typically the registering individual will provide identification and demographic information concerning their identity and contact information. In alternate embodiments of the present invention, the information requested by the operating group may be tailored to the specific informational needs of the operating group and its marketing partners.

Once an individual is registered with the operating group's website a confirmation electronic mail (“e-mail”) is sent to the individual containing marketing information from a marketing partner. The content of the marketing information may be determined by the operating group and/or any number of marketing partners.

The individual may then access features of the public website previously unavailable by inputting their determined user name and password. Once the individual is logged in they will be permitted to enter information about potential participants for the programs offered by the operating group. For example, a parent may be the individual who accesses the website and enters information for a child who wants to participate in a youth soccer league. The information required for a potential participant may be pre-determined by the operating group. It should be understood that in certain instances, the individual and the participant may be the same person.

Once the participant's initial information is entered by the individual, the website will present available programs that the participant is eligible to be registered for. The individual may select any number of programs for any number of entered participants.

Following the election of offered programs, the system dynamically creates additional participant information entry forms to be filled out by the individual. The information required to be entered will be specific to the selected program and the previously entered information of the participant. For example, a female youth participant being registered for a youth soccer league will be presented with a different form than a volunteer coach for a men's basketball league.

After input of the requested information, the system proceeds to offer a variety of selected products targeted to each participant for each program. The products are offered by the marketing partner of the offering group. Through the use of decision making software, specific products may be offered to specific participants. For example, a female youth participant registered for a youth soccer league will be presented with a different set of products available for purchase from the marketing partner than a volunteer coach for a men's basketball league

The system makes decisions on the presentation of products based on a number of factors. Typically these factors will include the chosen program, the participant's age, the participant's gender, the role of the participant, and the skill level of the participant. However, it should be noted that the criteria applied may be specific to the marketing partner's preferences as well.

In addition to registration capabilities, the system provides for maintenance functionality for the offered programs. For example the system may automatically generate rosters and schedules after registration is completed for an offered program. This greatly increases the incentive for an individual to revisit the website to obtain additional information. Thus, the number of opportunities for targeted marketing is also increased.

### BRIEF DESCRIPTION OF THE DRAWINGS

FIG. 1 depicts a flowchart showing the operation of the method described in the preferred embodiment of the invention for registering participants in offered programs and presenting targeted marketing based on the inputted information.

### DETAILED DESCRIPTION

It is to be understood that the invention is not limited in its application to the details of construction and the arrangement of components set forth in the following description or illustrated in the drawings.

Prior to the implementation of the preferred embodiment of the present invention, the operating group will either design on its own or design through any third party, a website accessible by the public over the Internet. Website creation and access through the Internet or other proprietary networks is well known in the art. The operating group can be any organization operating a sports league, a sports camp, or a sporting event. For the purposes of describing the preferred embodiment, the operating group, is herein identified as the recreational department of a city. It should be recognized that this is in no way limiting and only serves the purposes of simplifying the below description.

Also, in the preferred embodiment of the present invention, the operating group will have a marketing agreement with one or more marketing partners who seek to advertise and offer for sale their products on the website. However, it should be noted that the marketing agreement may between any parties that have a financial interest in the website, including web hosting companies, website maintainers, website designers or any related third party with a financial interest. For sake of description, it will be assumed that a marketing agreement exists between the operating group and a sporting goods provider. The marketing partner may be responsible for the content of the targeted content used through the website.

In the preferred embodiment of the present invention, the website will have an associated electronic mail server for the purpose of sending e-mails to users of the system which contain targeted content as determined by the marketing partner. For example, the system may send out a confirmation e-mail when an individual creates an account on the website which contains a targeted message from the marketing partner promoting its products. It should be understood that in alternate embodiments of the present invention, e-mails may be generated and sent out to individuals at pre-determined times, or based on pre-determined events. Thus, the marketing partner has multiple opportunities to send targeted marketing messages through e-mails to individuals.

For example, in one embodiment, the system may be configured in such a way to generate and send out a targeted marketing message as part of an e-mail to an individual after a participant is registered by an individual. In alternate embodiments of the present invention, such an e-mail may be sent at any of the following times: after the completion of a purchase of products offered by the marketing partner, upon making a payment to an open balance, upon determination of rosters in a sports league, upon determination of schedules, and at various other times as determined by the operating group and the marketing partner.

When such electronic mails are sent out, they may also be sent out as group e-mails, based on groups determined by the system. In the exemplary embodiment the e-mail may be sent to each of the participants in a 10-year-old girls soccer league by the operating group. In that example, the targeted content may include advertisements to products appropriate for that sport, age group, gender and skill level. It should be noted that in the preferred embodiment of the present invention, the system may be configured in such a way to make targeting decisions based on the above factors in any combination or by considering the role of the participants as well. Such rules are embedded in the software used to manage the website and may be altered to the specifications of the operating group and the marketing partner.

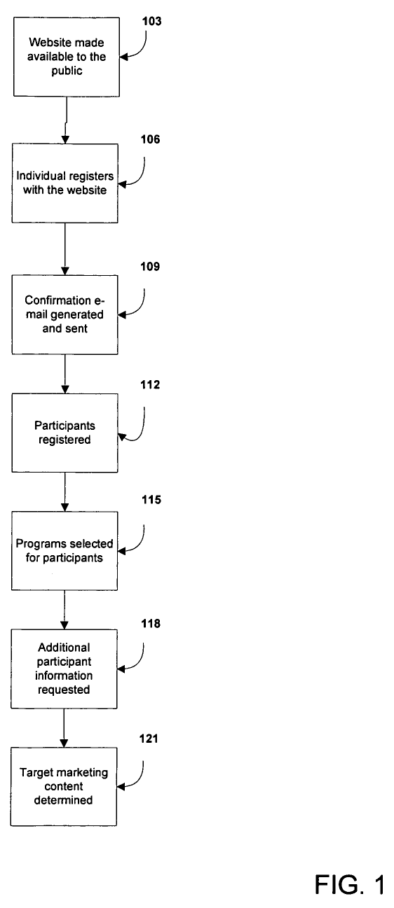

FIG. 1 shows the operation of the preferred method of operating the present invention. At step 103, the operating group's website is made available to the public on the Internet. This allows any individual with an interest in the programs offered by the operating group to visit the website and determine their level of interest. It should be noted that the number and types of programs offered by the operating group may range significantly between various operating groups during various sporting seasons.

For purposes of example, the operating group here may be offering at one time soccer leagues for various age groups, genders, and skill levels; and basketball leagues for various age groups, genders, and skill levels. In various embodiments of the system, the programs offered are only limited by being in the scope of sports leagues, sports camps, and sporting events.

The method proceeds to step 106, wherein an individual provides registration information in order to access the specific programs made available by the offering group. In the preferred embodiment of the present invention, the individual accesses the website through a web browser and is presented with a form for them to input this information into. The information required may be predetermined by the operating group, but will generally include identification information and demographic information about the individual. This information may be applied by the software to determine which products to include in targeted offers made by the marketing partner through e-mails and dynamically created web content.

After the system receives the requested information from the individual, in the preferred embodiment of the present invention, the method proceeds to step 109, where the system generates a confirmation e-mail to send to the individual whose information was received. This e-mail may contain targeted content from the marketing partner, determined by applying the inputted information to the software associated with the website. For example, if a mother of two children living in Atlanta, Ga. registers on the website, the e-mail may contain offers of sporting jerseys popular in that particular geographical area. The server associated with the website then sends this generated e-mail to the individual.

At this point, the website may create a user name and password for the individual to be used in subsequent visits to the website. This allows the software to recognize the individual and use the previously provided information for both offering programs and presenting targeted marketing. This also allows the individual to access the various registration and program management features offered on the website.

Once the individual has created an account with the website, in the preferred embodiment of the present invention, the method proceeds to step 112, where the individual may select any number of programs for any number of participants that they choose to register. To accomplish this task, the system first presents the individual with a form where the individual may register a participant. For example, in the exemplary embodiment of the present invention, the individual may first register her 12-year old son. The individual fills out the form with the information requested by the operating group. The individual has the opportunity to register as many participants as she chooses. In this example, she may next register her 8-year-old daughter.

In the preferred embodiment of the present invention, once the individual has registered the participants the method proceeds to step 115, wherein the system presents to the individual a listing of programs that are available for the participants to register for. In the exemplary embodiment, offered programs may include soccer leagues for various age groups, genders, and skill levels; and basketball leagues for various age groups, genders, and skill levels. The individual selects which programs each of the participants is to be registered for. In our example, the individual may choose to select the 8-year-old girl's soccer league for her eight-year-old girl and the 12-year-old boy's basketball league for her 12-year-old boy. In alternative embodiments of the present invention, it should be noted that the individual may also register themselves as a participant.

Once the selections are made by the individual as to which programs each participant is to be registered for, the method of the preferred embodiment of the present invention proceeds to step 118, wherein the website presents forms requesting additional participant information relevant to the selected program. Thus for example, the soccer league may require different information than the basketball league. The additional information required at this step is predetermined by the offering group presenting the programs.

Once the additional information is provided by the individual, in the preferred embodiment of the present invention, the method proceeds to step 121, wherein the software associated with the website makes a determination as to which products offered by the marketing partner to present to which participant. This determination is made through applying factors including age, sport, gender, role and skill level. The website then displays the product offered for each individual in a format that the individual may select various products for purchase.

In the exemplary embodiment of the present invention, the individual may be presented with a basketball, basketball shoes, and basketball shorts available to purchase for the twelve-year-old. The participant may also be presented with a soccer ball, soccer shoes and soccer jerseys available to purchase for the eight-year-old. The specific products offered is determined by applying the relevant factors in the software associated with the website. The software makes a determination of which products are most relevant for the participant. The website then offers these products for purchase at this step in the preferred method.

It should also be noted that in alternate embodiments of the present invention, the same software routine may be applied at any point while the individual is browsing the website. Thus, the system may display targeting marketing content, for example, in a reserved area within the viewable area of the webpage at any point in time.

Once products are selected, if any, the method proceeds to a checkout screen where the purchase amounts for the selected programs and products are totaled and presented to the individual. At this point, the individual may make payment to cover their selections and the registration process is finalized. It should be noted, that in the preferred embodiment of the system, the individual will have a number of reasons to revisit the website and create additional targeted marketing opportunities. On these subsequent visits, the individual will enter their assigned user name and password, which will allow the system to retrieve the information desirable for targeted marketing.

As a requirement of the present invention, the system must provide maintenance functionality for the programs provided by the offering group. This functionality is critical to providing a reason for the individual to return to the website on multiple subsequent occasions. One feature that may be offered in the preferred embodiment of the present invention is software which has the capability of creating rosters for teams within a sports league. The present system allows for an individual or participant to select a role within the selected program. For example, in a sports league, one could select the role of a referee, coach, team mother, manager, player, or volunteer. It should be understood that the above list is representative of the types of roles which may be available, but is in no way limiting.

The system has the capability of creating rosters by assigning groups of players to separate teams, and assigning coaches and other needed personnel to these teams. Thus, in an exemplary embodiment of the present invention, the posting of rosters provides another incentive for the individual to visit the website and be exposed to targeted marketing.

A further feature provided in the preferred embodiment of the present invention is game and practice scheduling functionality. Once the system has determined team rosters, a schedule including the times and locations of games and practices can be created and posted on the website. This creates yet another targeted marketing opportunity each and every time an individual logs on the website to view the upcoming schedule of events.

An important aspect of the present invention is the decision making process handled by the software associated with the website in determining the content of targeted marketing messages. As discussed above, in the preferred embodiment of the present invention, this determination is made through applying factors including age, sport, gender, role, and skill level. The marketing partner pre-determines products appropriate for marketing to subgroups meeting specific criteria combinations from these factors. The software matches these products to the inputted factors and can make a determination of which products to present to which participants when generating targeted marketing content.

Many modifications and other embodiments of the inventions set forth herein will come to mind to one skilled in the art to which these inventions pertain having the benefit of the teachings presented in the foregoing descriptions and the associated attachments. Therefore, it is to be understood that the inventions are not to be limited to the specific embodiments disclosed and that modifications and other embodiments are intended to be included within the scope of the present disclosure. Although specific terms are employed herein, they are used in a generic and descriptive sense only and not for purposes of limitation.

We claim:

1. A method of maintaining any number of sports leagues, sports camps, or sports events, comprising the steps of:
operating a publicly accessible website wherein selected content is controlled by an operating group which maintains any number of offered programs;
wherein each offered program consists of a league, camp, or event;
receiving registration information entered by an individual accessing the website which identifies the individual and provides demographic information about the individual;
sending an electronic mail to an electronic mail address provided by the individual wherein the electronic mail contains selected content from a marketing partner;
allowing the individual to register one or more participants in one or more programs presented by the operating group;
presenting registration forms dynamically based on participant information and program information;
presenting a targeted display of selected products for each participant from the marketing partner offered for purchase by the individual wherein the targeted display is based on the inputted participant information.

2. A computer-readable medium having stored thereon computer-executable instructions for performing the method of claim 1.

3. The method of claim 1 wherein the inputted participant information used to present the targeted display of selected products includes gender, age, and skill level.

4. The method of claim 1 further including the step of creating a user name and password associated with the individual for logging in to the website.

5. The method of claim 4 wherein a targeted display appears as a portion of the content on each webpage visited by an individual who has inputted their user name and password.

6. A computer-readable medium having stored thereon computer-executable instructions for performing the method of claim 5.

7. The method of claim 1 wherein the received registration information concerning each participant includes the relationship between the participant and the individual.

8. The method of claim 1 further including the step of receiving information of the role of the participant in the offered program.

9. A system of maintaining any number of sports leagues, sports camps, or sports events, comprising:
a publicly accessible website wherein selected content is controlled by an operating group which maintains any number of offered programs;
wherein each offered program consists of a league, camp, or event;
an interactive form to receive registration information entered by an individual accessing the website which identifies the individual and provides demographic information about the individual;
a server capable of sending electronic mail to an electronic mail address provided by the individual wherein the electronic mail contains selected content from a marketing partner;
a registration forms dynamically based on participant information and program information;
a targeted display of selected products for each participant from the marketing partner offered for purchase by the individual wherein the targeted display is based on the inputted participant information.

10. The system of claim 9 wherein a targeted display appears as a portion of the content on each webpage visited by an individual who has inputted their user name and password.

11. The system of claim 9 wherein the registration form concerning each participant requests the relationship between the participant and the individual.

12. The system of claim 9 wherein the registration form concerning each participant requests the role of the participant in the offered program.
